(19) United States
(12) Patent Application Publication
(10) Pub. No.: US 2018/0254982 A1
(43) Pub. Date: Sep. 6, 2018

(54) Communication Paths for Distributed Ledger Systems

(71) Applicant: Cisco Technology, Inc., San Jose, CA (US)

(72) Inventors: John George Apostolopoulos, Palo Alto, CA (US); Judith Ying Priest, Palo Alto, CA (US)

(21) Appl. No.: 15/446,992

(22) Filed: Mar. 1, 2017

(51) Int. Cl. H04L 12/725; H04L 29/08; H04L 12/911

(52) U.S. Cl. CPC H04L 45/302; H04L 47/726; H04L 67/10; H04L 67/34

(57) ABSTRACT

Various implementations disclosed herein enable adjusting the performance of at least a portion of communication paths associated with a distributed ledger. In various implementations, a method includes determining a quality of service value for a data transmission over the communication paths provided by a first plurality of network nodes. In some implementations, the data transmission is associated with the distributed ledger. In various implementations, the method includes determining one or more configuration parameters for at least one of the first plurality of network nodes based on a function of the quality of service value. In various implementations, the method includes providing the one or more configuration parameters to the at least one of the first plurality of network nodes.

### TECHNICAL FIELD

The present disclosure relates generally to distributed ledgers, and in particular, to communication paths for distributed ledger systems.

### BACKGROUND

Many traditional storage systems are centralized storage systems. In such storage systems, one or more servers serve as a central repository that stores information. The central repository is accessible to various client devices. The central repository is often managed by a business entity that typically charges a fee to access the central repository. In some instances, there is a transaction fee associated with each transaction. For example, there is often a transaction fee for writing information that pertains to a new transaction, and another transaction fee for accessing information related to an old transaction. As such, centralized storage systems tend to be relatively expensive. Some centralized storage systems are susceptible to unauthorized data manipulation. For example, in some instances, a malicious actor gains unauthorized access to the central repository, and surreptitiously changes the information stored in the central repository. In some scenarios, the unauthorized changes are not detected. As such, the information stored in a centralized repository is at risk of being inaccurate.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a schematic diagram of a distributed ledger environment that includes connecting nodes configured to provide communication paths for ledger nodes that maintain a distributed ledger in accordance with some implementations.

FIG. 2 is a schematic diagram that illustrates various communication paths provided by the connecting nodes in accordance with some implementations.

FIG. 3 is a block diagram of a controller that adjusts the performance of at least a portion of the communication paths in accordance with some implementations.

FIG. 4 is a block diagram of a controller that determines one or more configuration parameters based on a function of quality of service value(s) in accordance with some implementations.

FIG. 5 is a flowchart representation of a method of adjusting the performance of communication paths associated with a distributed ledger in accordance with some implementations.

FIG. 6 is a block diagram of a distributed ledger in accordance with some implementations.

FIG. 7 is a block diagram of a server system enabled with various modules that are provided to adjust the performance of communication paths associated with a distributed ledger in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION OF EXAMPLE EMBODIMENTS

Numerous details are described herein in order to provide a thorough understanding of the illustrative implementations shown in the accompanying drawings. However, the accompanying drawings merely show some example aspects of the present disclosure and are therefore not to be considered limiting. Those of ordinary skill in the art will appreciate from the present disclosure that other effective aspects and/or variants do not include all of the specific details of the example implementations described herein. While pertinent features are shown and described, those of ordinary skill in the art will appreciate from the present disclosure that various other features, including well-known systems, methods, components, devices, and circuits, have not been illustrated or described in exhaustive detail for the sake of brevity and so as not to obscure more pertinent aspects of the example implementations disclosed herein.

### Overview

Various implementations disclosed herein enable adjusting the performance of at least a portion of communication paths associated with a distributed ledger. For example, in various implementations, a method of adjusting the performance of the communication paths is performed by a controller configured to manage a first plurality of network nodes. In some implementations, the first plurality of network nodes are configured to provide communication paths for a second plurality of network nodes. In some implementations, the second plurality of network nodes are configured to maintain a distributed ledger using the communication paths. In various implementations, the controller includes one or more processors, a non-transitory memory, and one or more network interfaces. In various implementations, the method includes determining a quality of service value for a data transmission over the communication paths provided by the first plurality of network nodes. In some implementations, the data transmission is associated with the distributed ledger. In various implementations, the method includes determining one or more configuration parameters for at least one of the first plurality of network nodes based on a function of the quality of service value. In various implementations, the method includes providing the one or more configuration parameters to the at least one of the first plurality of network nodes.

### Example Embodiments

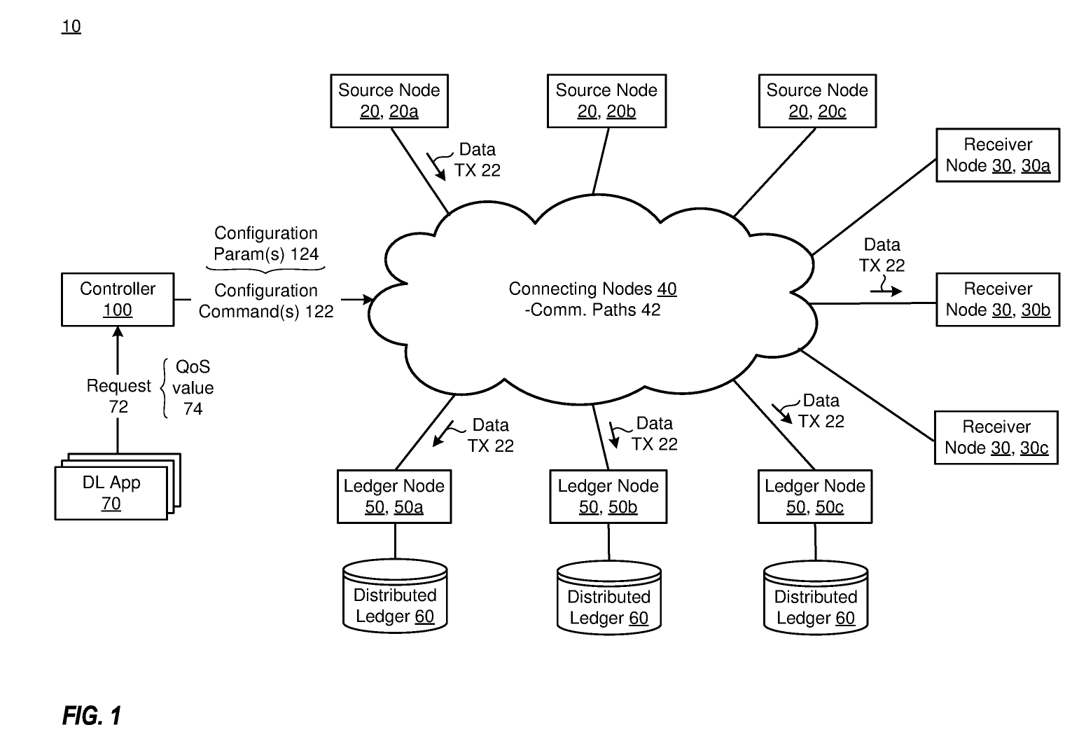

FIG. 1 is a schematic diagram of a distributed ledger environment 10. While certain specific features are illustrated, those of ordinary skill in the art will appreciate from the present disclosure that various other features have not been illustrated for the sake of brevity and so as not to obscure more pertinent aspects of the example implementations disclosed herein. To that end, the distributed ledger environment 10 includes one or more source nodes 20 (e.g., a first source node 20a, a second source node 20b and a third source node 20c), one or more receiver nodes 30 (e.g., a first receiver node 30a, a second receiver node 30b and a third receiver node 30c), various connecting nodes 40, various ledger nodes 50 (e.g., a first ledger node 50a, a second ledger node 50b and a third ledger node 50c), a distributed ledger 60, one or more distributed ledger applications 70, and a controller 100. Briefly, in various implementations, the connecting nodes 40 provide various communication paths 42 for the ledger nodes 50, and the controller 100 is configured to adjust the performance of at least a portion of the communication paths 42.

In various implementations, a source node 20 (e.g., the first source node 20a) initiates a data transmission 22. In various implementations, a data transmission 22 indicates (e.g., includes) information related to a transaction. In some implementations, the transaction is between a source node 20 and a receiver node 30 (e.g., between the first source node 20a and the second receiver node 30b). In various implementations, the transaction is recorded in the distributed ledger 60. As such, in various implementations, the source node 20 transmits the data transmission 22 to a receiver node 30 and the ledger nodes 50. In some implementations, the data transmission 22 includes a set of one or more packets, or frames. In some implementations, the data transmission 22 includes a data container such as a JSON (JavaScript Object Notation) object. In some implementations, the data transmission 22 includes one or more burst transmissions.

In various implementations, the connecting nodes 40 provide communication paths 42 for the data transmission 22. In some implementations, the communication paths 42 include one or more routes that the data transmission 22 traverses to reach the receiver node(s) 30 and/or the ledger nodes 50. In some implementations, the connecting nodes 40 are connected wirelessly (e.g., via satellite(s), cellular communication, Wi-Fi, etc.). In such implementations, the communication paths 42 include wireless communication paths. In some implementations, the connecting nodes 40 are connected via wires (e.g., via fiber-optic cables, Ethernet, etc.). In such implementations, the communication paths 42 include wired communication paths. More generally, in various implementations, the communication paths 42 includes wired and/or wireless communication paths.

In various implementations, the ledger nodes 50 generate and/or maintain the distributed ledger 60 in coordination with each other. In various implementations, the ledger nodes 50 store transactions in the distributed ledger 60. For example, in some implementations, the ledger nodes 50 store the transaction(s) indicated by the data transmission 22 in the distributed ledger 60. As such, in various implementations, the distributed ledger 60 serves as a record of the transactions that the distributed ledger 60 receives, validates, and/or processes. In various implementations, a ledger node 50 (e.g., each ledger node 50) stores a copy (e.g., an instance) of the distributed ledger 60. As such, in various implementations, there is no need for a centralized ledger.

In some implementations, one or more ledger nodes 50 (e.g., all the ledger nodes 50) receive the data transmission 22, and one of the ledger nodes 50 initiates the storage of the transaction(s) indicated by the data transmission 22 in the distributed ledger 60. In various implementations, the transaction(s) is (are) added to the distributed ledger 60 based on a consensus determination between the ledger nodes 50. For example, in some implementations, one of the ledger nodes 50 stores the transaction(s) in the distributed ledger 60 in response to receiving permission to store the transaction(s) in the distributed ledger 60 from a threshold number/percentage (e.g., a majority) of the ledger nodes 50. In various implementations, the ledger nodes 50 compete with each other to store the transaction in the distributed ledger 60. In some implementations, the distributed ledger 60 is referred to as a ledger store (e.g., a distributed ledger store).

In various implementations, the distributed ledger 60 is associated with one or more distributed ledger applications 70. In various implementations, a distributed ledger application 70 is associated with one or more particular types of transactions. For example, in some implementations, a distributed ledger application 70 is associated with high-frequency trading transactions. In such implementations, the distributed ledger application 70 is referred to as a high-frequency trading application. In some implementations, a distributed ledger application 70 is associated with supply chain management. In such implementations, the distributed ledger application 70 is referred to as a supply chain management application. In some implementations, a distributed ledger application 70 includes computer-readable instructions that execute on one or more source nodes 20, one or more receiver nodes 30, and/or one or more ledger nodes 50. In some implementations, a distributed ledger application 70 includes hardware that resides in one or more source nodes 20, one or more receiver nodes 30, and/or one or more ledger nodes 50.

In various implementations, a distributed ledger application 70 transmits a request 72 to the controller 100. In various implementations, the request 72 indicates a quality of service value 74 associated with the distributed ledger application 70. In some implementations, the quality of service value 74 indicates a time duration during which the quality of service value 74 is applicable. In some implementations, the quality of service value 74 includes a latency value that indicates an acceptable level of latency (e.g., an acceptable transmission time) for data transmissions 22 associated with the distributed ledger application 70. In some implementations, the quality of service value 74 indicates a priority level associated with data transmissions 22 related to the distributed ledger application 70. In some implementations, the quality of service value 74 indicates an acceptable level of errors for data transmissions 22 associated with the distributed ledger application 70.

In various implementations, the controller 100 adjusts the performance of at least a portion of the communication paths 42 based on a function of the quality of service value 74. In various implementations, the controller 100 determines the quality of service value 74. For example, in some implementations, the controller 100 receives the quality of service value 74 from a distributed ledger application 70. In various implementations, the controller 100 determines a configuration command 122 that indicates one or more configuration parameters 124 for at least one connecting node 40 based on a function of the quality of service value 74. In various implementations, the controller 100 transmits the configuration command 122 to a connecting node 40. In various implementations, the configuration command 122 causes the connecting node(s) 40 to adjust the performance of at least a portion of the communication paths 42. In the example of FIG. 1, the controller 100 is shown separate from the connecting nodes 40. However, in some implementations, the controller 100 resides in one or more connecting nodes 40. In some examples, the controller 100 is distributed across two or more connecting nodes 40.

In various implementations, the distributed ledger environment 10 is associated with a service-level agreement (SLA). In some implementations, a SLA defines one or more aspects of a service (e.g., quality of service, availability, responsibilities, etc.) provided by a service provider (e.g., an operator of the connecting nodes 40) to a client (e.g., the distributed ledger application 70). In some implementations, a SLA is in the form of a smart contract that is recorded in the distributed ledger 60. As such, in various implementations, the distributed ledger environment 10 (e.g., the ledger node(s) 50 and/or the controller 100) determines whether the terms of the SLA are being satisfied or breached. In other words, in various implementations, the distributed ledger environment 10 (e.g., the ledger node(s) 50 and/or the controller 100) verifies compliance with the SLA. In some implementations, the controller 100 receives an indication from the ledger node(s) 50 indicating whether the SLA is being satisfied or breached. In some implementations, the configuration command(s) 122 cause the connecting node(s) 40 to adjust the performance of at least a portion of the communication paths 42 in order to maintain compliance with the SLA.

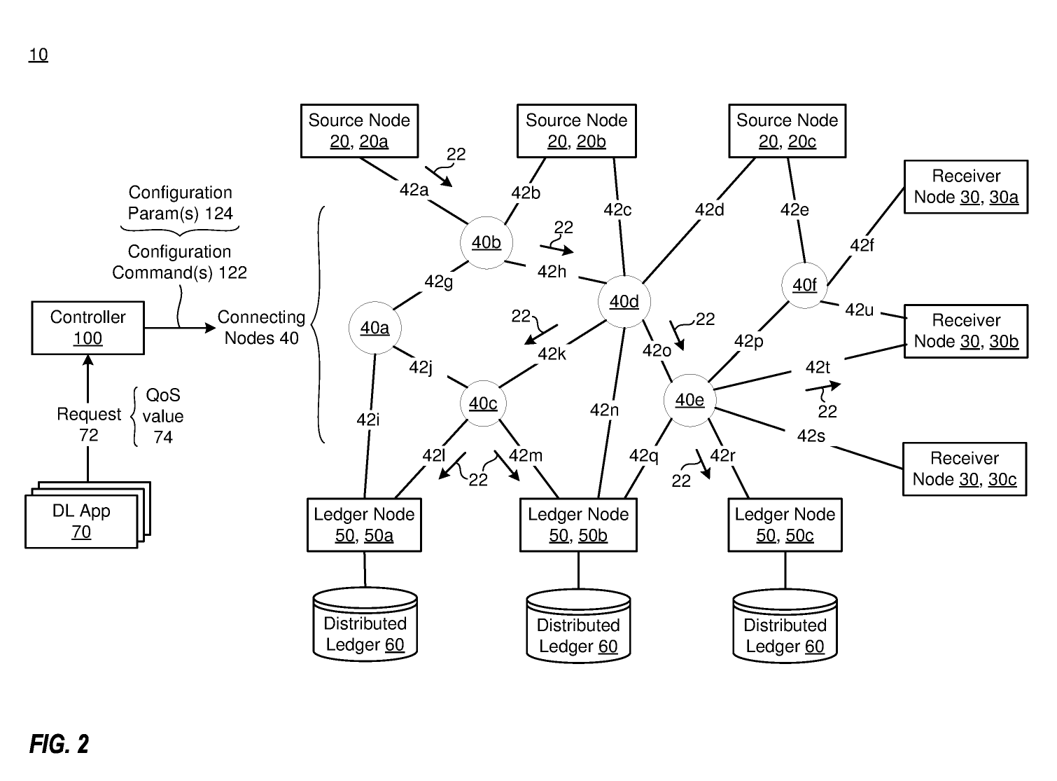

FIG. 2 is a schematic diagram that illustrates various communication paths 42 provided by the connecting nodes 40 in accordance with some implementations. In the example of FIG. 2, there are six connecting nodes 40 (e.g., connecting nodes 40a, 40b . . . 40f) that form various communication paths 42 (e.g., communication paths 42a, 42b . . . 42u). In various implementations, a communication path 42 provides a route for a data transmission 22. In the example of FIG. 2, the data transmission 22 reaches the first ledger node 50a by traveling over communication paths 42a, 42h, 42k and 42l, and through connecting nodes 40b, 40d and 40c. In the example of FIG. 2, the data transmission 22 reaches the second ledger node 50b by traveling over communication paths 42a, 42h, 42k and 42m, and through connecting nodes 40b, 40d and 40c. In the example of FIG. 2, the data transmission 22 reaches the third ledger node 50c by traveling over communication paths 42a, 42h, 42o and 42r, and through connecting nodes 40b, 40d and 40e. In the example of FIG. 2, the data transmission 22 reaches the second receiver node 30b by traveling over communication paths 42a, 42h, 42o and 42t, and through connecting nodes 40b, 40d and 40e.

In various implementations, the controller 100 determines the route of the data transmission 22 over the communication paths 42 and through the connecting nodes 40 based on a function of the quality of service value 74. In other words, in various implementations, the controller 100 determines which connecting nodes 40 and communication paths 42 are to transport the data transmission 22 based on a function of the quality of service value 74. In various implementations, the controller 100 indicates the route to the connecting nodes 40 via the configuration parameters 124. Put another way, in various implementations, the configuration parameters 124 indicate the route, and the controller 100 transmits the configuration parameters 124 to the connecting nodes 40 in the form of a configuration command 122. In some implementations, the controller 100 transmits the configuration command(s) 122 to connecting nodes 40 that are included in the route. In some implementations, the controller 100 forgoes transmitting the configuration command(s) 122 to connecting nodes 40 that are not included in the route.

In various implementations, a source node 20, a receiver node 30, a connecting node 40 and/or a ledger node 50 include any suitable computing device (e.g., a server computer, a desktop computer, a laptop computer, a tablet device, a netbook, an internet kiosk, a personal digital assistant, a mobile phone, a smartphone, a wearable, a gaming device, etc.) In some implementations, the source node 20, the receiver node 30, the connecting node 40 and/or the ledger node 50 include one or more processors, one or more types of memory, and/or one or more user interface components (e.g., a touch screen display, a keyboard, a mouse, a track-pad, a digital camera and/or any number of supplemental devices to add functionality). In some implementations, the source node 20, the receiver node 30, the connecting node 40 and/or the ledger node 50 include a suitable combination of hardware, software and firmware configured to provide at least some of protocol processing, modulation, demodulation, data buffering, power control, routing, switching, clock recovery, amplification, decoding, and error control.

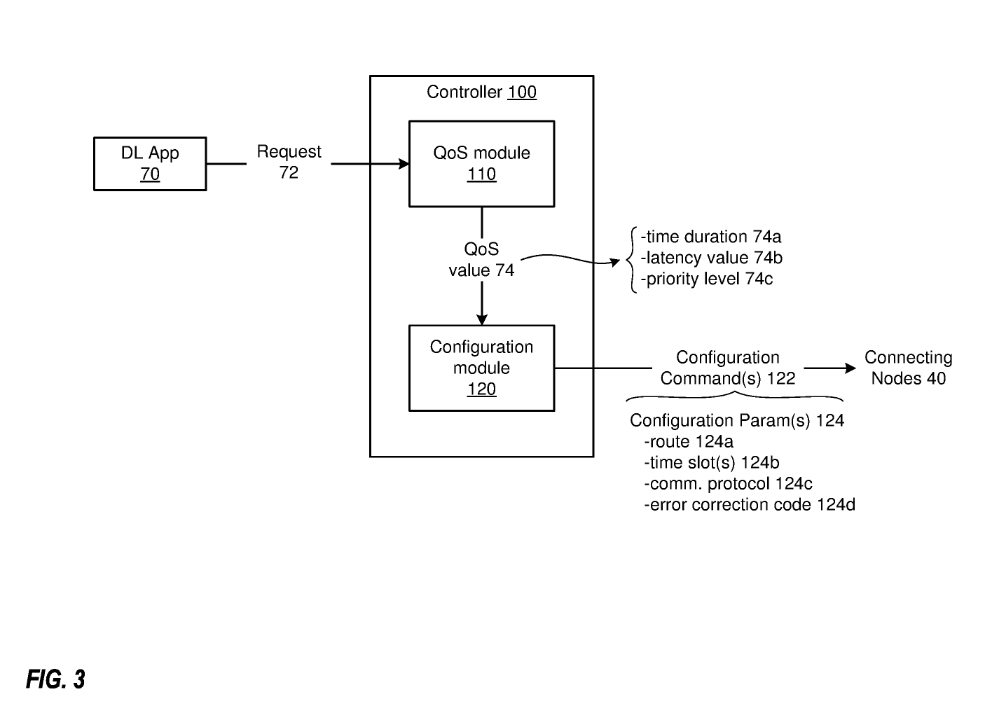

FIG. 3 is a block diagram of a controller 100 in accordance with some implementations. In various implementations, the controller 100 adjusts the performance of at least a portion of the communication paths 42 provided by the connecting nodes 40 based on a function of the quality of service value 74. In various implementations, the controller 100 includes a quality of service module 110 and a configuration module 120. Briefly, in various implementations, the quality of service module 110 determines the quality of service value 74, and the configuration module 120 determines one or more configuration parameters 124 based on a function of the quality of service value 74.

In various implementations, the quality of service module 110 determines the quality of service value 74. For example, in some implementations, the quality of service module 110 determines the quality of service value 74 by receiving a request 72 that indicates the quality of service value 74. In some implementations, the quality of service value 74 is associated with a type of data transmissions 22. For example, in some implementations, the quality of service value 74 is associated with data transmissions 22 that are related to a particular distributed ledger application 70. In such implementations, the quality of service value 74 applies to transactions that are related to that particular distributed ledger application 70.

In various implementations, the quality of service value 74 is associated with a time duration 74a, a latency value 74b, a priority level 74c, and/or other values/parameters. In some implementations, the quality of service value 74 is associated with a time duration 74a during which the quality of service value 74 is applicable. In some implementations, the quality of service value 74 includes a latency value 74b that indicates an acceptable amount of time for data transmissions 22 to propagate through the connecting nodes 40 and the communication paths 42 provided by the connecting nodes 40. In some implementations, the latency value 74b indicates an acceptable amount of time for a type of data transmissions 22 (e.g., data transmissions 22 associated with a particular distributed ledger application 70) to reach one or more ledger nodes 50 (e.g., all the ledger nodes 50). In some implementations, the quality of service value 74 includes a priority level 74c that applies to data transmissions 22 related to the distributed ledger application 70. In some examples, a high priority level applies to one type of data transmissions 22 (e.g., data transmissions 22 related to high-frequency trading), and a low priority level applies to another type of data transmissions 22 (e.g., data transmissions 22 related to supply chain management).

In various implementations, the configuration module 120 determines one or more configuration parameters 124 based on a function of the quality of service value 74. In various implementations, the configuration module 120 synthesizes one or more configuration commands 122 that include the configuration parameter(s) 124. In various implementations, the configuration module 120 transmits the configuration command(s) 122 to the connecting node(s) 40. In various implementations, the configuration parameter(s) 124 cause the connecting node(s) 40 to adjust the performance of at least a portion of the communication paths 42. As such, in various implementations, the controller 100 (e.g., the configuration module 120) causes the connecting nodes 40 to deliver the data transmissions 22 to the ledger nodes 50 in accordance with the quality of service value 74.

In various implementations, the configuration module 120 determines one or more configuration parameters 124 that indicate a route 124a for the data transmissions 22. In some implementations, the route 124a indicates the connecting nodes 40 and/or the communication paths 42 that the data transmissions 22 associated with the quality of service value 74 are to traverse. In some implementations, the configuration module 120 determines the route 124a in response to the time duration 74a satisfying a time threshold (e.g., in response to the time duration 74a being within a time period indicated by the time threshold). In some implementations, the configuration module 120 determines the route 124a in response to the latency value 74b breaching a latency threshold (e.g., in response to the latency value 74b being less than the latency threshold). In some implementations, the configuration module 120 determines the route 124a in response to the priority level 74c breaching a priority threshold (e.g., in response to the priority level 74c being greater than the priority threshold).

In some implementations, the configuration module 120 determines different routes 124a for data transmissions 22 associated with different quality of service values 74. For example, the configuration module 120 determines a first route 124a in response to the time duration 74a satisfying a time threshold, and a second route 124a in response to the time duration 74a breaching the time threshold. Similarly, in some implementations, the configuration module 120 determines a first route 124a in response to the latency value 74b breaching a latency threshold, and a second route 124a in response to the latency value 74b satisfying the latency threshold. In some implementations, the configuration module 120 determines a first route 124a in response to the priority level 74c breaching a priority threshold, and a second route 124a in response to the priority level 74c satisfying the priority threshold.

In various implementations, the configuration module 120 determines one or more configuration parameters 124 that indicate one or more time slots 124b during which the data transmissions 22 associated with the quality of service value 74 are transmitted. In various implementations, the time slot(s) 124b indicate one or more time duration(s) during which the connecting node(s) 40 process data transmissions 22 associated with the quality of service value 74. In some implementations, the configuration module 120 utilizes a variety of systems, devices and/or methods associated with time division multiplexing to determine the time slot(s) 124b. In various implementations, the configuration parameter 124 indicates one or more connecting nodes 40 that form a time sensitive network and/or a deterministic network. In other words, in some implementations, the configuration module 120 establishes/forms a time sensitive network and/or a deterministic network that includes one or more connecting nodes 40. In such implementations, the configuration parameters 124 indicate the connecting nodes 40 that are included in the time sensitive network and/or the deterministic network. In various implementations, the time sensitive network and/or the deterministic network utilize the time slot(s) 124b to deliver the data transmissions 22 to the ledger node(s) 50.

In various implementations, the configuration module 120 determines the time slot(s) 124b in response to the quality of service value 74 satisfying or breaching one or more thresholds. For example, in some implementations, the configuration module 120 determines the time slot(s) 124b in response to the time duration 74a satisfying a time threshold (e.g., in response to the time duration 74a being within a time period indicated by the time threshold). In some implementations, the configuration module 120 determines the time slot(s) 124b in response to the latency value 74b breaching a latency threshold (e.g., in response to the latency value 74b being less than the latency threshold). In some implementations, the configuration module 120 determines the time slot(s) 124b in response to the priority level 74c breaching a priority threshold (e.g., in response to the priority level 74c being greater than the priority threshold, for example, in response to the priority level 74c being high).

In various implementations, the configuration module 120 determines one or more configuration parameters 124 that indicate a communication protocol 124c for a type of data transmissions 22. For example, in some implementations, the configuration parameters 124 indicate a communication protocol 124c for delivering the data transmissions 22 associated with the distributed ledger application 70. In some implementations, the configuration module 120 determines different communication protocols 124c for data transmissions 22 associated with different distributed ledger applications 70. In some implementations, the configuration module 120 determines different communication protocols 124c for different types of data transmissions 22. In some implementations, the configuration module 120 determines different communication protocols 124c in response to different quality of service values 74.

In some implementations, the configuration module 120 determines User Datagram Protocol (UDP) as the communication protocol 124c in response to the latency value 74b breaching a latency threshold (e.g., in response to the latency value 74b being less than a latency threshold). In some implementations, the configuration module 120 determines UDP as the communication protocol 124c in response to the priority level 74c breaching a priority threshold (e.g., in response to the priority level 74c being greater than a priority threshold, for example, in response to the priority level 74c being high). In various implementations, UDP provides reliable fast delivery of data transmissions 22. In some implementations, the configuration module 120 determines Transmission Control Protocol (TCP) as the communication protocol 124c in response to the latency value 74b breaching a latency threshold (e.g., in response to the latency value 74b being greater than a latency threshold). In some implementations, the configuration module 120 determines TCP as the communication protocol 124c in response to the priority level 74c breaching a priority threshold (e.g., in response to the priority level 74c being less than a priority threshold, for example, in response to the priority level 74c being low). In various implementations, TCP provides reliable delivery of data transmissions 22 with potentially higher delay.

In various implementations, the configuration module 120 determines one or more configuration parameters 124 that indicate an error correction code 124d for encoding a type of data transmissions 22. For example, in some implementations, the configuration parameters 124 indicate an error correction code 124d for data transmissions 22 associated with the distributed ledger application 70. In some implementations, the configuration module 120 determines different error correction codes 124d for data transmissions 22 associated with different distributed ledger applications 70. In some implementations, the configuration module 120 determines different error correction codes 124d for data transmissions 22 associated with different quality of service values 74.

In some implementations, the configuration module 120 determines forward error correction (FEC) as the error correction code 124d in response to the latency value 74b breaching a latency threshold (e.g., in response to the latency value 74b being less than a latency threshold). In some implementations, the configuration module 120 determines FEC as the error correction code 124d in response to the priority level 74c breaching a priority threshold (e.g., in response to the priority level 74c being greater than a priority threshold, for example, in response to the priority level 74c being high). In some implementations, the configuration module 120 determines a retransmissions-based error correction scheme as the error correction code 124d in response to the latency value 74b breaching a latency threshold (e.g., in response to the latency value 74b being greater than a latency threshold). In some implementations, the configuration module 120 determines a retransmissions-based error correction scheme as the error correction code 124d in response to the priority level 74c breaching a priority threshold (e.g., in response to the priority level 74c being less than a priority threshold, for example, in response to the priority level 74c being low).

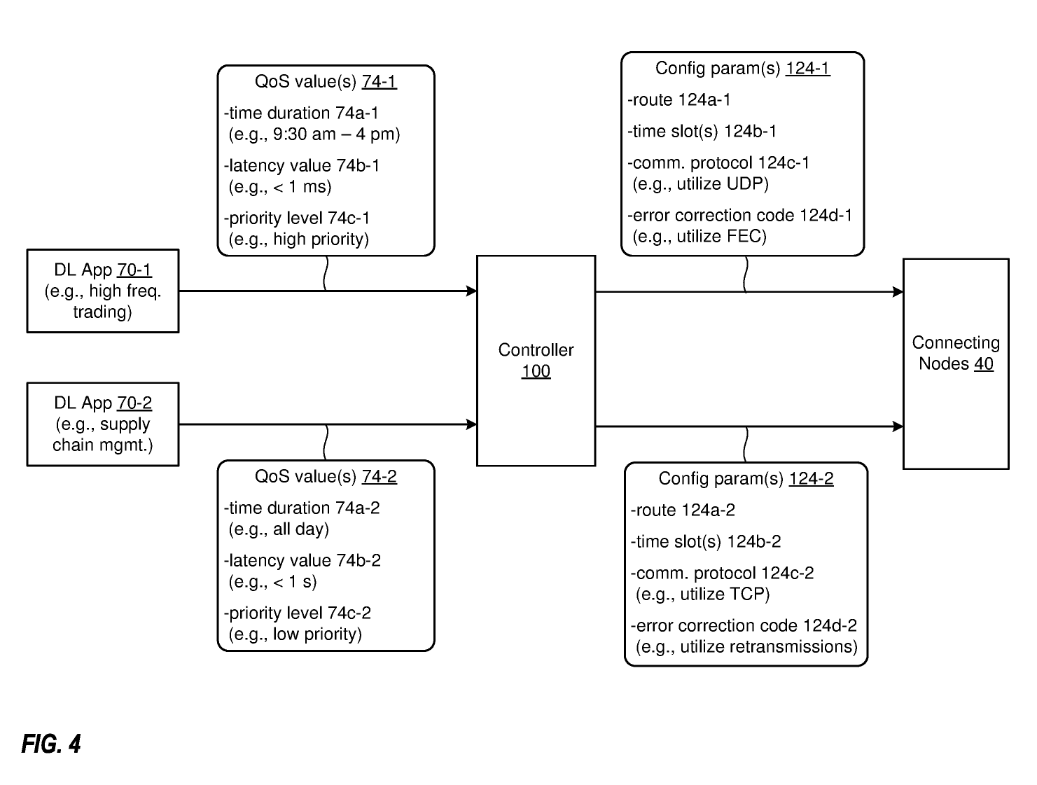

FIG. 4 is a block diagram of a controller 100 that determines one or more configuration parameters 124 based on a function of quality of service values 74 in accordance with some implementations. In the example of FIG. 4, there are two distributed ledger applications 70: a first distributed ledger application 70-1, and a second distributed ledger application 70-2. In some examples, the first distributed ledger application 70-1 includes a high frequency trading application. In some examples, the second distributed ledger application 70-2 includes a supply chain management application. In the example of FIG. 4, the controller 100 receives a first quality of service value 74-1 from the first distributed ledger application 70-1, and/or a second quality of service value 74-2 from the second distributed ledger application 70-2. In this example, the first quality of service value 74-1 is associated with data transmissions 22 related to the first distributed ledger application 70-1 (e.g., data transactions 22 related to high frequency trading). In this example, the second quality of service value 74-2 is associated with data transmissions 22 related to the second distributed ledger application 70-2 (e.g., data transmissions 22 related to supply chain management).

In various implementations, the first quality of service value 74-1 is different from the second quality of service value 74-2. For example, the first quality of service value 74-1 is associated with a first time duration 74a-1 (e.g., trading hours such as 9:30 am-4 pm EST), and the second quality of service value 74-2 is associated with a second time duration 74a-2 (e.g., all day) that is different from the first time duration 74a-1. In this example, the first quality of service value 74-1 is associated with a first latency value 74b-1 (e.g., a relatively short time duration for data transmissions 22 related to high frequency trading, for example, less than 1 millisecond), and the second quality of service value 74-2 is associated with a second latency value 74b-2 (e.g., a relatively longer time duration for data transmissions 22 related to supply chain management, for example, 1 second). In the example of FIG. 4, the first quality of service value 74-1 is associated with a first priority level 74c-1 (e.g., high priority for data transmissions 22 related to high frequency trading), and the second quality of service value 74-2 is associated with a second priority level 74c-2 (e.g., low priority for data transmissions 22 related to supply chain management).

As illustrated in FIG. 4, the controller 100 determines a first set of one or more configuration parameters 124-1 based on a function of the first quality of service value 74-1, and/or a second set of one or more configuration parameters 124-2 based on a function of the second quality of service value 74-2. In the example of FIG. 4, the first set of configuration parameters 124-1 are different from the second set of configuration parameters 124-2 (e.g., since the first quality of service value 74-1 is different from the second quality of service value 74-2). In this example, the first set of configuration parameters 124-1 indicate a first route 124a-1, and the second set of configuration parameters 124-2 indicate a second route 124a-2 that is different from the first route 124a-1. In other words, in some examples, data transmissions 22 related to the first distributed ledger application 70-1 traverse the first route 124a-1, whereas data transmissions 22 related to the second distributed ledger application 70-2 traverse the second route 124a-2.

In some implementations, the first set of configuration parameters 124-1 indicate a first set of one or more time slots 124b-1 for data transmissions 22 associated with the first distributed ledger application 70-1, and the second set of configuration parameters 124-2 indicate a second set of one or more time slots 124b-2 for data transmissions 22 associated with the second distributed ledger application 70-2. In some implementations, the first set of configuration parameters 124-1 indicate a first communication protocol 124c-1 for transporting data transmissions 22 associated with the first distributed ledger application 70-1, and the second set of configuration parameters 124-2 indicate a second communication protocol 124c-2 for transporting data transmissions 22 associated with the second distributed ledger application 70-2. In the example of FIG. 4, the first communication protocol 124c-1 includes UDP, and the second communication protocol 124c-2 includes TCP. In other words, in the example of FIG. 4, the controller 100 configures (e.g., instructs) the connecting nodes 40 to utilize UDP to transmit data transmissions 22 associated with the first distributed ledger application 70-1, and the controller 100 configures the connecting nodes 40 to utilize TCP to transmit data transmissions 22 associated with the second distributed ledger application 70-2.

In various implementations, the first set of configuration parameters 124-1 indicate a first error correction code 124d-1 for encoding data transmissions 22, and the second set of configuration parameters 124-2 indicate a second error correction code 124d-2 for encoding data transmissions 22. In the example of FIG. 4, the controller 100 configures the connecting nodes 40 to utilize FEC to encode data transmissions 22 associated with the first distributed ledger application 70-1, and the controller 100 configures the connecting nodes 40 to utilize a retransmissions-based error correction scheme to encode data transmissions 22 associated with the second distributed ledger application 70-2. More generally, in various implementations, the controller 100 configures the connecting nodes 40 to utilize FEC to encode data transmissions 22 in response to the quality of service value 74 indicating a latency value 74b that breaches a latency threshold, and/or a priority level 74c that breaches a priority threshold (e.g., latency value 74b is less than a latency threshold, and/or priority level 74c is greater than a priority threshold). Similarly, in various implementations, the controller 100 configures the connecting nodes 40 to utilize a retransmissions-based error correction scheme to encode data transmissions 22 in response to the quality of service value 74 indicating a latency value 74b that breaches a latency threshold, and/or a priority level 74c that breaches a priority threshold (e.g., latency value 74b is greater than a latency threshold, and/or priority level 74c is less than a priority threshold).

In various implementations, the controller 100 obtains a systemic view of the distributed ledger environment 10, and determines the configuration parameters 124 based on a function of the systemic view. In some implementations, the systemic view indicates a travel time for data transmissions 22 to traverse one or more communication paths 42. In some examples, the controller 100 obtains a systemic view that includes travel times for each communication path 42. In such implementations, the controller 100 determines the configuration parameters 124 based on a function of the travel times. For example, the controller 100 determines a route 124a, a time slot 124b, a communication protocol 124c and/or an error correction code 124d that reduces the travel time. In some implementations, the systemic view indicates end-to-end latency, bandwidth and/or losses between source nodes 20, and receiver nodes 30, ledger nodes 50 and/or distributed ledger applications 70. In such implementations, the controller 100 determines the configuration parameters 124 based on a function of the end-to-end latency, bandwidth and/or losses indicated by the systemic view. For example, the controller 100 determines a route 124a, a time slot 124b, a communication protocol 124c and/or an error correction code 124d that reduces the end-to-end latency, conserves bandwidth and/or reduces losses.

In some implementations, the controller 100 receives information regarding a status (e.g., a current status) of a connecting node 40 and/or a communication path 42. For example, in some implementations, the controller 100 receives (e.g., periodically receives) status updates from the connecting nodes 40. In some implementations, the controller 100 utilizes the status of the connecting nodes 40 and/or the communication paths 42 to determine the systemic view of the distributed ledger environment 10. As such, in various implementations, the systemic view indicates characteristics of the distributed ledger environment 10, one or more connecting nodes 40, and/or one or more communication paths 42. In such implementations, the controller 100 determines the configuration parameters 124 based on a function of the characteristics indicated by the systemic view. For example, the controller 100 determines a route 124a that avoids connecting nodes 40 that are malfunctioning, congested and/or unavailable. In various implementations, determining the configuration parameters 124 based on a function of the systemic view improves performance of the distributed ledger environment 10 (e.g., by providing faster responses and/or higher throughput).

In various implementations, the controller 100 determines the configuration parameters 124 based on a data transmission schedule associated with one or more source nodes 20, one or more receiver nodes 30, one or more ledger nodes 50, and/or one or more distributed ledger applications 70. In some implementations, the controller 100 determines (e.g., obtains) a data transmission schedule that indicates a time at which a data transmission 22 will occur or is likely to occur. In some implementations, the controller 100 determines the data transmission schedule based on previous data transmissions 22. In some examples, a particular source node 20 sends data transmissions 22 to a particular receiver node 30 periodically (e.g., every 10 seconds, 1 second, 10 milliseconds, etc.). In such examples, the controller 100 determines a data transmission schedule based on the periodicity of previous data transmissions 22 between that particular source node 20 and that particular receiver node 30. In such examples, the data transmission schedule indicates times at which subsequent data transmissions 22 will likely occur between that particular source node 20 and that particular receiver node 30.

In some implementations, the controller 100 receives the data transmission schedule from the source node(s) 20, the receiver node(s) 30, the ledger node(s) 50 and/or the distributed ledger application(s) 70. For example, in some implementations, the controller 100 receives a data transmission schedule that indicates a time at which a particular source node 20 is scheduled to send a data transmission 22. Similarly, in some implementations, the controller 100 receives a data transmission schedule that indicates a time at which a particular receiver node 30 is scheduled to receive a data transmission 22. In various implementations, the controller 100 determines the configuration parameters 124 based on a function of the data transmissions schedule. For example, in some implementations, the controller 100 determines the configuration parameters 124 in advance of the time(s) indicated by the data transmission schedule, so that the configuration parameters 124 are in effect at the time(s) indicated by the data transmission schedule. In some implementations, the controller 100 determines the configuration parameters 124 a threshold amount of time prior to the time(s) indicated by the data transmission schedule. In some implementations, the configuration parameters 124 are revoked after the time(s) indicated by the data transmission schedule has passed. In various implementations, determining the configuration parameters 124 based on a function of the data transmission schedule enables the controller 100 to satisfy the quality of service value 74 (e.g., one or more delivery requirements) associated with the scheduled data transmissions 22.

In various implementations, the controller 100 determines the configuration parameters 124 based on a function of a workload associated with the distributed ledger environment 10 and/or an amount of cross-traffic on the communication paths 42. In some implementations, the workload associated with the distributed ledger environment 10 indicates a number of data transmissions 22 and/or transactions being processed by the distributed ledger 60. In some implementations, the cross-traffic on the communication paths 42 relates to other usages of the communication paths 42 (e.g., usages other than transmitting the data transmissions 22). In various implementations, the workload associated with the distributed ledger environment 10 and/or the amount of cross-traffic on the communication paths 42 vary over time. In some implementations, the controller 100 determines the configuration parameters 124 in response to detecting a threshold change in the workload and/or the cross-traffic.

In some implementations, the controller 100 determines a route 124a that avoids communication paths 42 with cross-traffic that breaches (e.g., exceeds) a cross-traffic threshold. In some implementations, the controller 100 determines UDP as the communication protocol 124c in response to the workload breaching (e.g., exceeding) a workload threshold and/or the cross-traffic breaching (e.g., exceeding) a cross-traffic threshold. In some implementations, the controller 100 determines FEC as the error correction code 124d in response to the workload breaching (e.g., exceeding) a workload threshold and/or the cross-traffic breaching (e.g., exceeding) a cross-traffic threshold. In various implementations, determining the configuration parameters 124 based on a function of the workload and/or the cross-traffic enables the controller 100 to improve the performance of the distributed ledger environment 10 (e.g., by making the communication paths 42 more robust). In various implementations, determining the configuration parameters 124 based on a function of the workload and/or the cross-traffic enables the distributed ledger 60 to operate without numerous disruptions or significant slow-downs during transient high-traffic conditions.

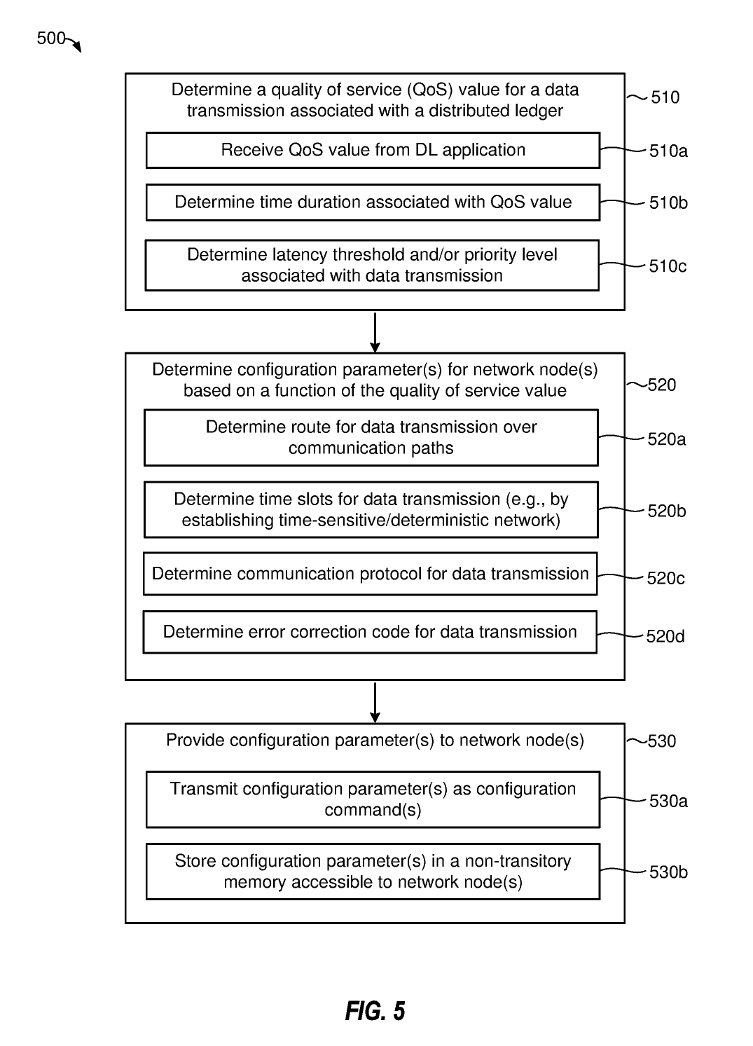

FIG. 5 is a flowchart representation of a method 500 of adjusting the performance of communication paths (e.g., the communication paths 42 shown in FIGS. 1 and 2) associated with a distributed ledger (e.g., the distributed ledger 60 shown in FIGS. 1 and 2) in accordance with some implementations. In various implementations, the method 500 is implemented as a set of computer readable instructions that are executed at a controller (e.g., the controller 100 shown in FIGS. 1-4). Briefly, the method 500 includes determining a quality of service value for a data transmission associated with a distributed ledger, determining one or more configuration parameters for network nodes that provide communication paths for the distributed ledger based on a function of the quality of service value, and providing the configuration parameter(s) to the network node(s).

As represented by block 510, in various implementations, the method 500 includes determining a quality of service value (e.g., the quality of service value 74 shown in FIGS. 1-4) for a data transmission associated with a distributed ledger. As represented by block 510a, in some implementations, the method 500 includes receiving the quality of service value from a distributed ledger application (e.g., the distributed ledger application 70 shown in FIGS. 1-4). In some examples, the method 500 includes receiving a request (e.g., the request 72 shown in FIGS. 1-3) that indicates the quality of service value. In some such implementations, the quality of service value is associated with data transmissions related to the distributed ledger application.

As represented by block 510b, in various implementations, the method 500 includes determining a time duration (e.g., the time duration 74a shown in FIGS. 3 and 4) associated with the quality of service value. In some implementations, the time duration indicates a time period during which the quality of service value applies to a type of data transmissions. In some implementations, the method 500 includes reading the time duration from a request. As represented by block 510c, in various implementations, the method 500 includes determining a latency value (e.g., the latency value 74b shown in FIGS. 3 and 4) associated with the data transmission. In some implementations, the method 500 includes reading the latency value from a request. As represented by block 510c, in various implementations, the method 500 includes determining a priority level (e.g., the priority level 74c shown in FIGS. 3 and 4) associated with the data transmission. In some implementations, the method 500 includes reading the priority level from a request.

As represented by block 520, in various implementations, the method 500 includes determining one or more configuration parameters (e.g., the configuration parameter(s) 124 shown in FIGS. 1-4) for at least one network node (e.g., at least one of the connecting nodes 40 shown in FIGS. 1-4) based on a function of the quality of service value. As represented by block 520a, in various implementations, the method 500 includes determining a route (e.g., route 124a shown in FIGS. 3 and 4) for the data transmission over the communication paths. In some implementations, the method 500 includes determining different routes for data transmissions associated with different quality of service values (e.g., determining a first route 124a-1 for data transmissions 22 associated with a first distributed ledger application 70-1, and determining a second route 124a-2 for data transmissions 22 associated with a second distributed ledger application 70-2, as shown in FIG. 4). In various implementations, the method 500 includes determining the route based on a function of the quality of service value. For example, in some implementations, the method 500 includes determining the route based on a function of a time duration, a latency value, and/or a priority level indicated by the quality of service value.

In some implementations, the method 500 includes determining a shorter/faster route even if the shorter/faster route is more expensive (e.g., computationally and/or financially) in response to the latency value breaching a latency threshold (e.g., in response to the latency value being less than a latency threshold). In some implementations, the method 500 includes determining a cheaper route (e.g., computationally and/or financially) even if the cheaper route is longer/slower in response to the latency value breaching a latency threshold (e.g., in response to the latency value being greater than a latency threshold). In some implementations, the method 500 includes determining a shorter/faster route even if the shorter/faster route is more expensive (e.g., computationally and/or financially) in response to the priority level breaching a priority threshold (e.g., in response to the priority level being greater than a priority threshold, for example, in response to the priority level being high). In some implementations, the method 500 includes determining a cheaper route (e.g., computationally and/or financially) even if the cheaper route is longer/slower in response to the priority level breaching a priority threshold (e.g., in response to the priority level being less than a priority threshold, for example, in response to the priority level being low).

As represented by block 520b, in various implementations, the method 500 includes determining one or more time slots (e.g., time slots 124b shown in FIGS. 3 and 4) for the data transmission. In some implementations, the method 500 includes determining different time slots for data transmissions associated with different distributed ledger applications (e.g., determining a first set of one or more time slot(s) 124b-1 for data transmissions 22 associated with the first distributed ledger application 70-1, and determining a second set of one or more time slot(s) 124b-2 for data transmissions 22 associated with the second distributed ledger application 70-2, as shown in FIG. 4). In some implementations, determining the time slot(s) includes establishing (e.g., forming) a time sensitive network (TSN) and/or a deterministic network (detnet). In such implementations, the TSN and/or the detnet transport the data transmission during the time slot(s).

In various implementations, the method 500 includes determining to establish a TSN and/or a detnet based on a function of the quality of service value. For example, in some implementations, the method 500 includes determining to establish a TSN and/or a detnet based on a function of a time duration, a latency value, and/or a priority level indicated by the quality of service value. In some implementations, the method 500 includes determining to establish a TSN and/or a detnet in response to the latency value breaching a latency threshold (e.g., in response to the latency value being less than a latency threshold). In some implementations, the method 500 includes determining to establish a TSN and/or a detnet in response to the priority level breaching a priority threshold (e.g., in response to the priority level being greater than a priority threshold, for example, in response to the priority level being high).

As represented by block 520c, in various implementations, the method 500 includes determining a communication protocol (e.g., the communication protocol 124c shown in FIGS. 3 and 4) for the data transmission. In some implementations, the method 500 includes determining different communication protocols for data transmissions associated with different quality of service values (e.g., determining a first communication protocol 124c-1 for data transmissions 22 associated with a first distributed ledger application 70-1, and determining a second communication protocol 124c-2 for data transmissions 22 associated with a second distributed ledger application 70-2, as shown in FIG. 4).

In various implementations, the method 500 includes determining the communication protocol based on a function of the quality of service value. For example, in some implementations, the method 500 includes determining the communication protocol based on a function of a time duration, a latency value, and/or a priority level indicated by the quality of service value. In some implementations, the method 500 includes determining UDP as the communication protocol in response to the latency value breaching a latency threshold (e.g., in response to the latency value being less than a latency threshold). In some implementations, the method 500 includes determining UDP as the communication protocol in response to the priority level breaching a priority threshold (e.g., in response to the priority level being greater than a priority threshold, for example, in response to the priority level being high). In some implementations, the method 500 includes determining TCP as the communication protocol in response to the latency value breaching a latency threshold (e.g., in response to the latency value being greater than a latency threshold). In some implementations, the method 500 includes determining TCP as the communication protocol in response to the priority level breaching a priority threshold (e.g., in response to the priority level being less than a priority threshold, for example, in response to the priority level being low).

As represented by block 520d, in various implementations, the method 500 includes determining an error correction code (e.g., the error correction code 124d shown in FIGS. 3 and 4) for encoding the data transmission. In some implementations, the method 500 includes determining different error correction codes for data transmissions associated with different distributed ledger applications (e.g., determining a first error correction code 124d-1 for data transmissions 22 associated with a first distributed ledger application 70-1, and determining a second error correction code 124d-2 for data transmissions 22 associated with a second distributed ledger application 70-2, as shown in FIG. 4).

In various implementations, the method 500 includes determining the error correction code based on a function of the quality of service value. For example, in some implementations, the method 500 includes determining the error correction code based on a function of a time duration, a latency value, and/or a priority level indicated by the quality of service value. In some implementations, the method 500 includes determining FEC as the error correction code in response to the latency value breaching a latency threshold (e.g., in response to the latency value being less than a latency threshold). In some implementations, the method 500 includes determining FEC as the error correction code in response to the priority level breaching a priority threshold (e.g., in response to the priority level being greater than a priority threshold, for example, in response to the priority level being high). In some implementations, the method 500 includes determining a retransmissions-based error correction scheme as the error correction code in response to the latency value breaching a latency threshold (e.g., in response to the latency value being greater than a latency threshold). In some implementations, the method 500 includes a retransmissions-based error correction scheme as the error correction code in response to the priority level breaching a priority threshold (e.g., in response to the priority level being less than a priority threshold, for example, in response to the priority level being low).

As represented by block 530, in various implementations, the method 500 includes providing the configuration parameter(s) to one or more network nodes that provide the communication paths for the distributed ledger. As represented by block 530a, in some implementations, the method 500 includes transmitting the configuration parameter(s) to the network node(s). In some implementations, the method 500 includes transmitting the configuration parameter(s) to the network nodes that are included in a route indicated by the configuration parameter(s). In some implementations, the method 500 includes forgoing transmitting the configuration parameter(s) to network nodes that are not included in a route indicated by the configuration parameter(s). As represented by block 530b, in various implementations, the method 500 includes storing the configuration parameter(s) in a non-transitory memory that is accessible to the network nodes. In such implementations, the method 500 includes providing the configuration parameters to the network nodes by granting the network nodes access to the non-transitory memory that stores the configuration parameters.

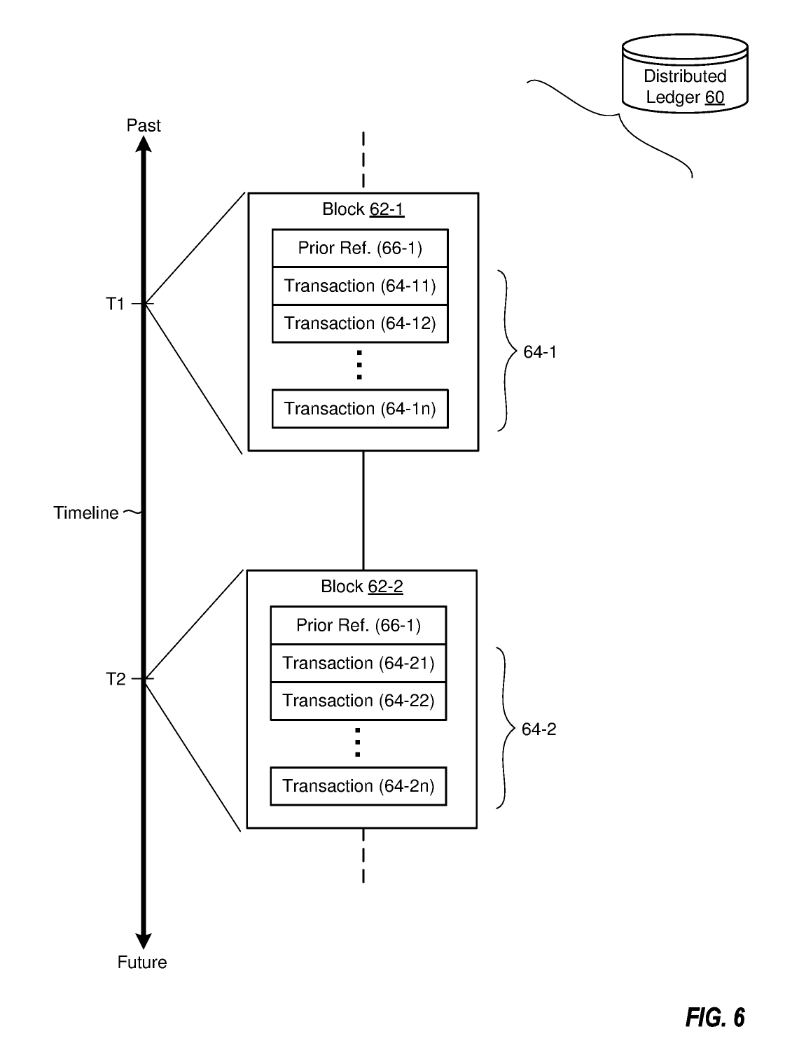

FIG. 6 is a block diagram of a distributed ledger 60 in accordance with some implementations. In various implementations, the distributed ledger 60 includes various blocks 62 (e.g., a first block 62-1 and a second block 62-2). In various implementations, a block 62 includes a set of one or more transactions 64. For example, the first block 62-1 includes a first set of transactions 64-1, and the second block 62-2 includes a second set of transactions 64-2. In various implementations, the transactions 64 are added to the distributed ledger 60 based on a consensus determination between the ledger nodes 50. For example, in some implementations, a transaction 64 is added to the distributed ledger 60 in response to a majority of the ledger nodes 50 determining to add the transaction 64 to the distributed ledger 60. As illustrated by the timeline, the first block 62-1 was added to the distributed ledger 60 at time T1, and the second block 62-2 was added to the distributed ledger 60 at time T2. In various implementations, the controller 100 and/or the ledger nodes 50 control a time difference between block additions. In various implementations, the first block 62-1 includes a reference 66-1 to a prior block (not shown), and the second block 62-2 includes a reference 66-2 to the first block 62-1. In various implementations, the blocks 62 include additional and/or alternative information such as a timestamp and/or other metadata.

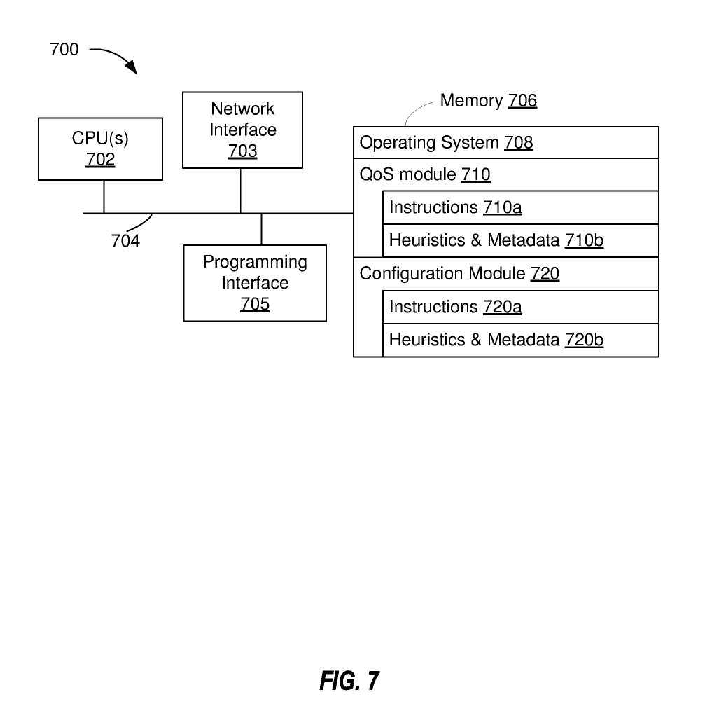

FIG. 7 is a block diagram of a server system 700 enabled with one or more components of a controller (e.g., the controller 100 shown in FIGS. 1-4) in accordance with some implementations. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the server system 700 includes one or more processing units (CPUs) 702, a network interface 703, a programming interface 705, a memory 706, and one or more communication buses 704 for interconnecting these and various other components.

In some implementations, the network interface 703 is provided to, among other uses, establish and maintain a metadata tunnel between a cloud hosted network management system and at least one private network including one or more compliant devices. In some implementations, the communication buses 704 include circuitry that interconnects and controls communications between system components. The memory 706 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 706 optionally includes one or more storage devices remotely located from the CPU(s) 702. The memory 706 comprises a non-transitory computer readable storage medium.

In some implementations, the memory 706 or the non-transitory computer readable storage medium of the memory 706 stores the following programs, modules and data structures, or a subset thereof including an optional operating system 708, a quality of service module 710, and a configuration module 720. In various implementations, the quality of service module 710 and the configuration module 720 are similar to the quality of service module 110 and the configuration module 120, respectively, shown in FIG. 3. In various implementations, the quality of service module 710 determines a quality of service value (e.g., the quality of service value 74 shown in FIGS. 1-4). To that end, in various implementations, the quality of service module 710 includes instructions and/or logic 710a, and heuristics and metadata 710b. In various implementations, the configuration module 720 determines one or more configuration parameters based on a function of the quality of service value (e.g., the configuration parameters 124 shown in FIGS. 1-4). To that end, in various implementations, the configuration module 720 includes instructions and/or logic 720a, and heuristics and metadata 720b.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first contact could be termed a second contact, and, similarly, a second contact could be termed a first contact, which changing the meaning of the description, so long as all occurrences of the “first contact” are renamed consistently and all occurrences of the second contact are renamed consistently. The first contact and the second contact are both contacts, but they are not the same contact.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a controller configured to manage a first plurality of network nodes, wherein the first plurality of network nodes are configured to provide communication paths for a second plurality of network nodes, wherein the second plurality of network nodes are configured to maintain a distributed ledger using the communication paths:
determining a quality of service value for a data transmission over the communication paths provided by the first plurality of network nodes, wherein the data transmission is associated with the distributed ledger;
determining one or more configuration parameters for at least one of the first plurality of network nodes based on a function of the quality of service value; and
providing the one or more configuration parameters to the at least one of the first plurality of network nodes, wherein the one or more configuration parameters cause the at least one of the first plurality of the network nodes to adjust the performance of at least a portion of the communication paths provided to the second plurality of network nodes managing the distributed ledger.

2. The method of claim 1, wherein determining the quality of service value comprises:
receiving a request that indicates the quality of service value.

3. The method of claim 1, wherein determining the quality of service value comprises:
determining a time duration associated with the quality of service value.

4. The method of claim 1, wherein determining the quality of service value comprises one or more of:
determining a latency value associated with the data transmission; and
determining a priority level associated with the data transmission.

5. The method of claim 1, wherein determining the one or more configuration parameters comprises:
determining a route for the data transmission over the communication paths, wherein the one or more configuration parameters indicate the route.

6. The method of claim 1, wherein determining the one or more configuration parameters comprises:
determining one or more time slots during which the at least one of the first plurality of network nodes is to process the data transmission.

7. The method of claim 1, wherein determining the one or more configuration parameters comprises:
determining a communication protocol for the data transmission.

8. The method of claim 1, wherein determining the one or more configuration parameters comprises:
determining an error correction code for encoding the data transmission.

9. The method of claim 1, wherein providing the one or more configuration parameters to the at least one of the first plurality of network nodes comprises:
transmitting, to the at least one of the first plurality of network nodes, a configuration command that includes the one or more configuration parameters.

10. The method of claim 1, wherein the data transmission is associated with one of a first application and a second application; and
wherein determining the quality of service value for the data transmission comprises:
determining a first quality of service value for the data transmission in response to the data transmission being associated with a first application; and
determining a second quality of service value for the data transmission in response to the data transmission being associated with a second application.

11. The method of claim 1, wherein at least one of the second plurality of network nodes coordinates with one or more of the first plurality of network nodes to provide at least a portion of the communication paths for at least another one of the second plurality of network nodes.

12. The method of claim 1, wherein determining the one or more configuration parameters comprises:
determining a travel time for the data transmission between at least two of the first plurality of network nodes, wherein the function of determining the one or more configuration parameters is also based on the travel time.

13. The method of claim 1, wherein determining the one or more configuration parameters comprises:
determining a data transmission schedule for the data transmission, wherein the data transmission schedule indicates a time at which the data transmission will occur, wherein the function of determining the one or more configuration parameters is also based on the data transmission schedule.

14. The method of claim 1, wherein determining the one or more configuration parameters comprises:
determining one or more of a workload associated with the distributed ledger and an amount of cross-traffic on the communication paths, wherein the function of determining the one or more configuration parameters is also based on a combination of one or more of the workload associated with the distributed ledger and the amount of cross-traffic on the communication paths.

15. A controller configured to manage a first plurality of network nodes that provide communication paths for a second plurality of network nodes, wherein the second plurality of network nodes are configured to maintain a distributed ledger using the communication paths, the controller comprising:
a processor configured to execute computer readable instructions included on a non-transitory memory; and
a non-transitory memory including computer readable instructions, that when executed by the processor, cause the controller to:
determine a quality of service value for a data transmission over the communication paths provided by the first plurality of network nodes, wherein the data transmission is associated with the distributed ledger;
determine one or more configuration parameters for at least one of the first plurality of network nodes based on a function of the quality of service value; and
provide the one or more configuration parameters to the at least one of the first plurality of network nodes, wherein the one or more configuration parameters cause the at least one of the first plurality of the network nodes to adjust the performance of at least a portion of the communication paths provided to the second plurality of network nodes managing the distributed ledger.

16. The controller of claim 15, wherein the computer readable instructions cause the controller to determine the quality of service value by one or more of:
receiving a request that indicates the quality of service value; and
determining a time duration associated with the quality of service value.

17. The controller of claim 15, wherein the computer readable instructions cause the controller to determine the quality of service value by one or more of:
determining a latency value associated with the data transmission; and
determining a priority level associated with the data transmission.

18. The controller of claim 15, wherein the computer readable instructions cause the controller to determine the one or more configuration parameters by:
determining a route for the data transmission over the communication paths, wherein the one or more configuration parameters indicate the route.

19. The controller of claim 15, wherein the computer readable instructions cause the controller to determine the one or more configuration parameters by one or more of:
determining one or more time slots during which the at least one of the first plurality of network nodes is to process the data transmission;
determining a communication protocol for the data transmission; and
determining an error correction code for encoding the data transmission.

20. A distributed ledger system comprising:
a first plurality of network nodes that are configured to maintain a distributed ledger in coordination with each other;
a second plurality of network nodes that are configured to provide communication paths for the first plurality of network nodes; and
a controller that is configured to manage the second plurality of network nodes, wherein the controller comprises:
a processor configured to execute computer readable instructions included on a non-transitory memory; and
a non-transitory memory including computer readable instructions, that when executed by the processor, cause the controller to:
determine a quality of service value for a data transmission over the communication paths provided by the second plurality of network nodes, wherein the data transmission is associated with the distributed ledger;
determine one or more configuration parameters for at least one of the second plurality of network nodes based on a function of the quality of service value; and
provide the one or more configuration parameters to the at least one of the second plurality of network nodes, wherein the one or more configuration parameters cause the at least one of the second plurality of the network nodes to adjust the performance of at least a portion of the communication paths provided to the first plurality of network nodes managing the distributed ledger.
